(19) United States
(12) Patent Application Publication
(10) Pub. No.: US 2021/0272532 A1
(43) Pub. Date: Sep. 2, 2021

(54) SYSTEMS AND METHODS FOR AUTOMATICALLY ADJUSTING DISPLAY SYSTEM USING USER TRACKING

(71) Applicant: EDAN INSTRUMENTS, INC., Shenzhen (CN)

(72) Inventor: Richard HENDERSON, Shenzhen (CN)

(21) Appl. No.: 17/321,387

(22) Filed: May 14, 2021

Related U.S. Application Data
(63) Continuation of application No. PCT/CN2021/073377, filed on Jan. 22, 2021.

(30) Foreign Application Priority Data
Jan. 24, 2020 (US) 62965439

(51) Int. Cl. G09G 5/00; G06T 7/73; G06F 3/01

(52) U.S. Cl. CPC G09G 5/003; G06T 7/73; G09G 2370/22; G09G 2320/0261; G09G 2320/028; G06F 3/017

(57) ABSTRACT

Systems and methods for automatically adjusting an ultrasound display are provided according to one or more embodiments. The present disclosure provides a method for automatically adjusting a display, the method including: initializing an automated display control; receiving image data; determining a position or an orientation of a target relative to the display based on the image data; calculating an adjustment of the display based on the position or the orientation of the target relative to the display; and controlling at least one actuator based on the adjustment of the display to move the display.

### CROSS REFERENCE

The present application is a continuation-application of International (PCT) Patent Application No. PCT/CN2021/073377, filed on Jan. 22, 2021, which claims priority of US Patent Application No. 62/965,439, filed on Jan. 24, 2020, the entire contents of which are hereby incorporated by reference in its entirety.

### TECHNICAL FIELD

The present disclosure relates generally to the field of ultrasound display systems, more particularly to systems and methods for automatically adjusting display systems using user tracking.

### BACKGROUND

In diagnostic medical products, such as ultrasound systems, displays can output of information by projecting graphical data on a screen that a user can view. Displays can receive input of information through a graphical user interface that presents a series of options for the user to select.

### SUMMARY OF THE DISCLOSURE

Various embodiments of the disclosure relate to a computing system. The computing system may include a display for viewing data to a user during a procedure, actuators coupled to the display configured to adjust at least one of a position or an orientation of the display, and one or more image capture devices for capturing images of a local environment. The computing system may locate a target object within the images captured by the image capture devices. The computing system may relate the target object's location within the images to a location within the local environment. The computing system may determine an adjustment to the display to improve the visibility or viewing angle for the user. The computing system may cause the actuators to adjust at least one of the position or orientation of the display based on the calculated adjustment. The computing system may repeat this process according to a frequency or time delay. The computing system may also comprise an audio capture device in which voice commands can cause the actuators to adjust the position or orientation of the display. The computing system may be configured to operate according to specified parameters or preferences. The computing system may be configured to track more than one target objects. The computing system may also be configured with glare-reduction technology.

Various embodiments of the disclosure relate to a method implemented by a computing system. The method may comprise receiving image data from an image capture device. The method may comprise identifying an object within the image data. The method may comprise locating the object within the local environment. The method may comprise determining an adjustment to the display based on the location of the object within the local environment. The method may comprise causing actuators coupled to the computing system to adjust at least one of a position or orientation of a display based on the determined adjustments. The method may repeat itself according to a frequency or delay period. The method may include receiving voice commands from an audio capture device and causing the actuators to adjust the position or orientation of the display based on the voice command. The method may include identifying and tracking a second object, and causing the actuators to adjust the position or orientation of the display based on the second object.

Various embodiments of the disclosure relate to a computing system. The computing system may comprise a display for viewing data to a user during a procedure, actuators coupled to the display and configured to adjust the position and/or orientation of the display, and a transducer device capable of communicating with a remote beacon. The remote beacon may be worn on the person of the user as they move about the local environment. The computing system may transmit a first signal to the beacon. The beacon may send a second signal to the computing system in response to the first signal. The computing system may receive the second signal from the beacon and determine a location of the beacon within the local environment. The computing system may cause the actuators to adjust at least one of the position or orientation of the display based on the determined location of the beacon. The computing system may operate according to performance parameters and user settings. The computing system may include an audio capture device configured to receive voice commands and cause the actuators to adjust at least one of the position or orientation of the display based on the voice command. The computing system send and receive signals to more than one beacon and adjust the display based on the location of the more than one beacons.

Various embodiments of the disclosure relate to a method for automatically adjusting a display. The method may include: initializing an automated display control; receiving image data; determining a position or an orientation of a target relative to the display based on the image data; calculating an adjustment of the display based on the position or the orientation of the target relative to the display; and controlling at least one actuator based on the adjustment of the display to move the display.

The foregoing summary is illustrative only and is not intended to be limiting in any way. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 depicts an example of an environment in which a display system that can be automatically adjusted responsive to user tracking can be used.

FIG. 2 depicts an example of an ultrasound display.

FIG. 3 depicts an example of an ultrasound system.

FIG. 4 is a block diagram of an example of an ultrasound system.

FIG. 5 is a block diagram of an example of a display adjustment controller.

FIG. 6 is a flow diagram of an example of a method for automatically adjusting a display using user tracking.

FIG. 7A depicts an example of object motion tracking in a two-dimensional (2-D) floor plan in a scene.

FIG. 7B depicts the example of object motion tracking as shown in FIG. 7A in another scene.

FIG. 8A depicts an example of object motion tracking in a scene.

FIG. 8B depicts the example of object motion tracking as shown in FIG. 8A in another scene.

FIG. 9 is a flow diagram of an example of a method for infra-red tracking display adjustment.

### DETAILED DESCRIPTION

Before turning to the figures which illustrate the exemplary embodiments in detail, it should be understood that the application may not be limited to the details or methodology set forth in the description or illustrated in the figures. It should also be understood that the terminology may be for the purpose of description only, and should not be regarded as limiting.

Referring to the figures generally, automated display control devices, systems, and methods are disclosed with advantageous form factor, modularity, user interface, and/or display manipulation features. The various features of the present disclosure can be implemented in a variety of display systems, including but not limited to, medical imaging displays (e.g., ultrasound, computer tomography (CT) imaging, or magnetic resonance imaging (MRI) displays).

The disclosure provides a solution to improve medical display systems. In the varied medical environments in which a user may utilize diagnostic medical systems, the user may rely on a user interface display to be presented information during a procedure (such as, but not limited to, an examination, test, operation, or other medical procedure). The user may be in or switch between a variety of positions in order to perform the required tasks of the procedure, and as such, the user's viewing angle of the display may change. At large viewing angles (used interchangeably with off-angle viewing angles), the output quality of the display may appear diminished and cause the user to have difficulty viewing the information displayed on the screen or difficulty in providing input to the user interface. Other factors can exist, such as undesired glare reflections, which compromise the visibility of the information that the user sees or compromises the input access to the user interface controls on a display.

The present disclosure provides a solution to these challenges by implementing systems that automatically track a user as they move about an environment and adjusting the display accordingly such that adequate visibility of the display is maintained. In some embodiments, the system includes glare-reduction methods and devices to reduce glare interference automatically. With these improvements, a user would no longer need to manually adjust the display each time they change positions in the environment, or have a second person in the room to adjust the display for them. Some previous display systems have used a remote user input device and a combination of motors attached on the display such that the user could adjust the screen remotely; however, these too may not always be ideal in that controlling a display manually can be tedious and frustrating to a user. In addition, in procedures that require the user to use both hands, a user cannot both operate the remote device and perform the procedure at the same time (e.g., in the context of an ultrasound procedure, a user may use one hand to operate the ultrasound probe and another to operate a user interface, such as a keyboard, and thus would have no available hands to operate a remote device). Embodiments of the present disclosure provides a hands-free solution in which a user could perform the procedure without having to stop to adjust the display.

In various embodiments, an ultrasound system, such as a portable ultrasound cart system, can include a platform, an ultrasound system positioned on the platform, hookups/connectors and/or mounting/holding structures for ultrasound devices and tools (e.g., transducers/probes, gels, bottles, wipes, etc.), handles, power supplies (e.g., batteries, backup batteries). The ultrasound system can include an ultrasound electronics module, a display, sensors, and additional components and electronics (e.g., power supply, processors, memories, etc.). The ultrasound electronics module can be modular and/or removable, such that the ultrasound cart system can be customized, upgraded, or otherwise modified to suit specific user requirements. The ultrasound electronics module can include one or more user interfaces. The display can be attached to the platform and, in some embodiments, can include sensor(s) positioned along a perimeter of the display. The ultrasound system can include other sensors, such as image sensors, proximity sensors, acoustical sensors, or infrared sensors. The platform can include a housing. The housing can include actuation components located inside the housing and configured to control/articulate the position and orientation of the display, such as for shifting the display along a first axis (e.g., traverse axis passing from a first side to a second side of the platform), rotating the display about a second axis (e.g., swivel axis substantially perpendicular to a plane of the platform), and/or rotating the display about a third axis (e.g., tilt axis parallel to or collinear with the first axis). In some embodiments, the position and orientation of the display can be controlled electronically by controlling the actuation components based on at least one of a plurality of sensors and/or user input received at the one or more input interfaces of the ultrasound electronics module. In some embodiments, the position and orientation of the display can additionally or alternatively be adjusted manually based on user input received at the sensor(s) positioned along the perimeter of the display and forces applied to the display. Embodiments of the automated display control systems as disclosed herein can provide, among other features, advantageous form factor, modularity, user interface, and display manipulation features, such as by allowing the display to be directly attached to the platform and controlled electronically, manually, or both electronically and manually, locating the actuation components for controlling/articulating the display position and orientation inside the housing, using a modular ultrasound electronics module that can be replaced by a user, etc.

In the various embodiments of the disclosure, an ultrasound system can automatically adjust at least one of a display's position or orientation according to a tracked object in its environment. Object tracking can be based on input from various sensors in an ultrasound system, such as image capture devices, audio capture devices, user input devices, wireless signal transmitter/receivers, or other devices. The system can operate in an automatic tracking mode, wherein the system tracks a target in a series of images and adjusts the display accordingly. The system can analyze input from various input and sensor interfaces, calculate a desired display pose adjustment, and actuate the motors to make the adjustment according to determined parameters. When automatic tracking mode is disengaged or otherwise interrupted, the system will adjust the display upon manual instruction or input, such as, but not limited to, voice commands via the audio capture device, gesture input via a user input device such as a keyboard, mouse, trackpad, or remote controller, or manual manipulation of the physical display. Some embodiments include additional or alternative features, such as, but not limited to, voice command control interruptions, voice tracking, wireless-signal beacon tracking, glare-reduction methods or devices, or other features. Embodiments may include an initialization process for a user to adjust system settings.

The tracked target can be a variety of features. In some embodiments, the target is identified as the user's face or eyes. In some embodiments, the target is identified as the user's torso. In some embodiments, the target is indicated as the user's entire body. In some embodiments, the target is a beacon carried by the user. In some embodiments, the identity of the target can influence how the automated display control system will adjust the screen.

Various use scenarios may illustrate potential operation according to some embodiments. For example, a practitioner may prepare for an ultrasound examination by initializing the ultrasound display system for automatic tracking. As the practitioner moves about the room during the examination, the practitioner may prefer for automatic tracking to be engaged. If the practitioner is going to remain stationary for an extended period of time, they may prefer to disengage automatic tracking. The practitioner may vocalize a voice command to adjust the display up or down. In low-visibility conditions, the system may use a beacon tracking system, rather than the image tracking system, to track the practitioner in the room. Several other use scenarios exist in which the disclosed systems and methods can be used to improve medical display systems.

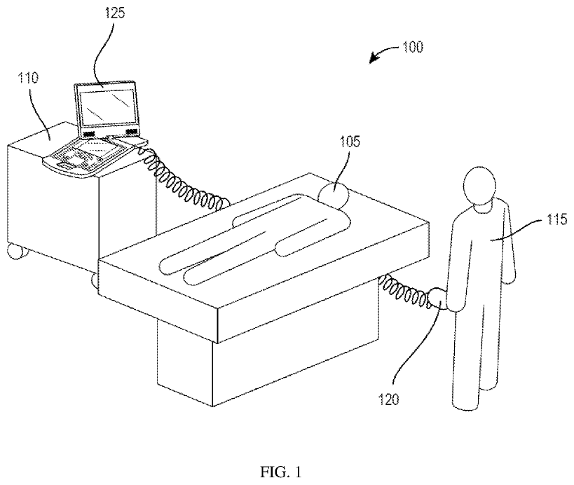

Referring to FIG. 1, an environment 100 for a medical procedure is depicted. Environment 100 can include a patient 105, a medical device 110, and an operator 115. The medical device 110 can be any medical device, such as, but not limited to, a medical imaging device, a surgical device, or a diagnostic device. In some embodiments, medical device 110 is an ultrasound system used to generate ultrasound images. Medical device 310 can include a handheld tool 120 and a display 125. The operator 115 may use the medical device 310 to perform some procedure or diagnostic on patient 105. The operator 115 can also use a handheld tool 120 associated with the medical device 310 to perform said procedure or diagnostic. The operator may also use the display 125 before, during, or after a procedure to analyze various measurements, parameters, or otherwise relevant data related to the procedure.

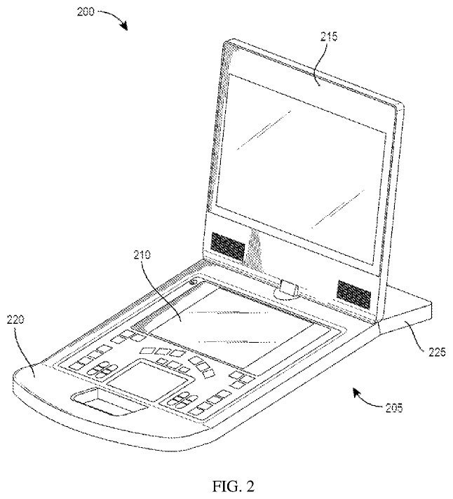

Referring now to FIG. 2, a portable ultrasound system 200 is shown in accordance with some embodiments. The portable ultrasound system 200 can include a platform 205 to house components of portable ultrasound system 200, an electronics module 210 received in the platform 205 that can include processing electronics, a display 215 attached to the platform 205 for a user to view information, and handles 220 attached to the platform 205 adjacent to where ultrasound electronics module 210 are received in the platform 205 for moving, carrying, or handling the portable ultrasound system 200. The handle(s) 225 may be positioned on an opposite side of the platform 205 from the handles 220.

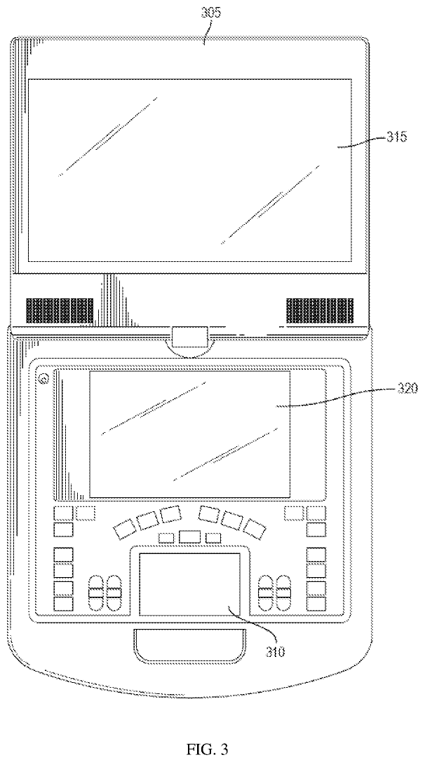

Referring now to FIG. 3, display 215 and electronics module 210 of the portable ultrasound system 200 are shown in accordance with some embodiments. The display 215 can include a display screen (e.g., main screen 315). The electronics module 210 can include one or more user interfaces, such as touchscreens 310, 320. The main screen 315 and the touchscreens 310, 320 can display information, such as diagnostic information related to a procedure. The touchscreens 310, 320 can receive user input, such as touch input from a user's fingers, from a touch device (e.g., stylus, pen), etc. In some embodiments, the main screen 315 may be a touchscreen or include one or more touch-sensitive or otherwise selectable portions. In some embodiments, the main screen 315 may include one or more sensors, such as proximity sensors, image sensors, brightness sensors, infrared sensors, or acoustical sensors. Alternatively, the platform 205 may include the one or more sensors.

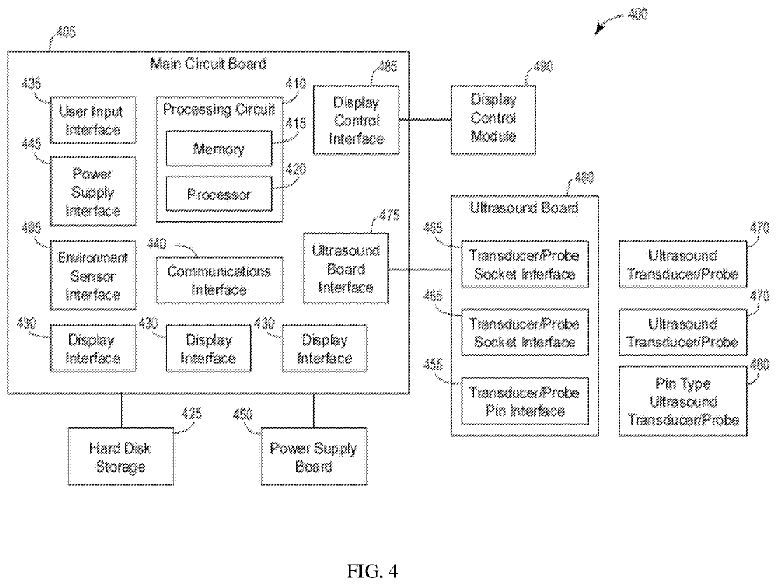

Referring now to FIG. 4, the portable ultrasound system 200 can include a main circuit board 405. The main circuit board 405 carries out computing tasks to support the functions of the portable ultrasound system 200 and provides connection and communication between various components of the portable ultrasound system 200. In some embodiments, the main circuit board 405 is configured so as to be a replaceable and/or upgradable module.

To perform computational, control, and/or communication tasks, the main circuit board 405 includes a processing circuit 410. The processing circuit 410 is configured to perform general processing and to perform processing and computational tasks associated with specific functions of the portable ultrasound system 200. For example, the processing circuit 410 may perform calculations and/or operations related to producing an image from signals and or data provided by the imaging equipment, running an operating system for the portable ultrasound system 200, receiving user inputs, etc. The processing circuit 410 may include a memory 415 and a processor 420 for use in processing tasks. For example, the processing circuit may perform calculations and/or operations.

A processor 420 may be, or may include, one or more microprocessors, application specific integrated circuits (ASICs), circuits containing one or more processing components, a group of distributed processing components, circuitry for supporting a microprocessor, or other hardware configured for processing. The processor 420 is configured to execute computer code. The computer code may be stored in a memory 415 to complete and facilitate the activities described herein with respect to the portable ultrasound system 200. In other embodiments, the computer code may be retrieved and provided to the processor 420 from a hard disk storage 425 or a communications interface 440 (e.g., the computer code may be provided from a source external to main circuit board 405).

The memory 415 can be any volatile or non-volatile computer-readable storage medium capable of storing data or computer code relating to the activities described herein. For example, the memory 415 may include modules which are computer code modules (e.g., executable code, object code, source code, script code, machine code, etc.) configured for execution by processor 420. The memory 415 may include computer executable code related to functions including ultrasound imaging, battery management, handling user inputs, displaying data, transmitting and receiving data using a wireless communication device, etc. In some embodiments, processing circuit 410 may represent a collection of multiple processing devices (e.g., multiple processors, etc.). In such cases, the processor 420 represents the collective processors of the devices and the memory 415 represents the collective storage devices of the devices. When executed by the processor 420, the processing circuit 410 is configured to complete the activities described herein as associated with the portable ultrasound system 200.

A hard disk storage 425 may be a part of a memory 415 and/or used for non-volatile long term storage in the portable ultrasound system 200. The hard disk storage 425 may store local files, temporary files, ultrasound images, patient data, an operating system, executable code, and any other data for supporting the activities of the portable ultrasound system 200 described herein. In some embodiments, the hard disk storage is embedded on the main circuit board 405. In other embodiments, the hard disk storage 425 is located remote from the main circuit board 405 and coupled thereto to allow for the transfer of data, electrical power, and/or control signals. The hard disk 425 may be an optical drive, magnetic drive, a solid state hard drive, flash memory, etc.

In some embodiments, the main circuit board 405 includes a communications interface 440. The communications interface 440 may include connections that enable communication between components of the main circuit board 405 and the communications hardware. For example, the communications interface 440 may provide a connection between the main circuit board 405 and a network device (e.g., a network card, a wireless transmitter/receiver, etc.). In some embodiments, the communications interface 440 may include additional circuitry to support the functionality of attached communications hardware or to facilitate the transfer of data between communications hardware and the main circuit board 405. In other embodiments, the communications interface 440 may be a system on a chip (SOC) or other integrated system which allows for transmission of data and reception of data. In such a case, the communications interface 440 may be coupled directly to the main circuit board 405 as either a removable package or embedded package.

Some embodiments of the portable ultrasound system 200 include a power supply board 450. The power supply board 450 includes components and circuitry for delivering power to components and devices within and/or attached to the portable ultrasound system 200. In some embodiments, the power supply board 450 includes components for alternating current and direct current conversion, for transforming voltage, for delivering a steady power supply, etc. These components may include transformers, capacitors, modulators, etc. to perform the above functions. In some embodiments, the power supply board 450 includes circuitry for determining the available power of a battery power source. The power supply board 450 can include circuitry for switching between power sources. For example, the power supply board 450 may draw power from a backup battery while a main battery is switched. In some embodiments, the power supply board 450 includes circuitry to operate as an uninterruptable power supply in conjunction with a backup battery. The power supply board 450 also includes a connection to the main circuit board 405. This connection may allow the power supply board 450 to send and receive information from the main circuit board 405. For example, the power supply board 450 may send information to the main circuit board 405 allowing for the determination of remaining battery power. The connection to the main circuit board 405 may also allow the main circuit board 405 to send commands to the power supply board 450. For example, the main circuit board 405 may send a command to the power supply board 450 to switch from source of power to another (e.g., to switch to a backup battery while a main battery is switched). In some embodiments, the power supply board 450 is configured to be a module. In such cases, the power supply board 450 may be configured so as to be a replaceable and/or upgradable module.

A main circuit board 405 may also include a power supply interface 430 which facilitates the above described communication between the power supply board 450 and the main circuit board 405. The power supply interface 430 may include connections which enable communication between components of the main circuit board 405 and the power supply board 450. In some embodiments, the power supply interface 430 includes additional circuitry to support the functionality of the power supply board 450. For example, the power supply interface 430 may include circuitry to facilitate the calculation of remaining battery power, manage switching between available power sources, etc. In other embodiments, the above described functions of the power supply board 450 may be carried out by a power supply interface 430. For example, the power supply interface 430 may be a SOC or other integrated system. In such a case, the power supply interface 430 may be coupled directly to the main circuit board 405 as either a removable package or an embedded package. The power supply interface 430 may be configured to facilitate communication between the power supply board 450 and other components, such as an ultrasound board 480.

With continued reference to FIG. 4, some embodiments of the main circuit board 405 include a user input interface 435. The user input interface 435 may include connections which enable communication between components of the main circuit board 405 and the user input device hardware. For example, the user input interface 435 may provide a connection between the main circuit board 405 and a capacitive touchscreen, resistive touchscreen, mouse, keyboard, buttons, and/or a controller for the preceding. In some embodiments, the user input interface 435 couples controllers for a touchscreen 110, a touchscreen 120, and a main screen 315 to the main circuit board 405. In other embodiments, the user input interface 435 includes controller circuitry for a touchscreen 310, a touchscreen 320, and a main screen 315. In some embodiments, the main circuit board 405 includes a plurality of user input interfaces 435. For example, each user input interface 435 may be associated with a single input device (e.g., a touchscreen 310, a touchscreen 320, a keyboard, buttons, etc.). In some embodiments, one or more user input interfaces 435 may be associated with sensors of display 215 (e.g., sensors positioned along a perimeter of display 215 for receiving user inputs for controlling the position and orientation of display 215, etc.).

In some embodiments, the user input interface 435 may include additional circuitry to support the functionality of attached user input hardware or to facilitate the transfer of data between user input hardware and the main circuit board 405. For example, the user input interface 435 may include controller circuitry so as to function as a touchscreen controller. The user input interface 435 may also include circuitry for controlling haptic feedback devices associated with user input hardware. In other embodiments, the user input interface 435 may be a SOC or other integrated system which allows for receiving user inputs or otherwise controlling user input hardware. In such a case, the user input interface 435 may be coupled directly to the main circuit board 405 as either a removable package or embedded package.

In some embodiments, the electronics module 210 includes a diagnostics board 480. In some embodiments, the diagnostics board 480 is an ultrasound system. The main circuit board 405 may include an ultrasound board interface 475 which facilitates communication between the ultrasound board 480 and the main circuit board 405. The ultrasound board interface 475 may include connections which enable communication between components of the main circuit board 405 and the ultrasound board 480. In some embodiments, the ultrasound board interface 475 includes additional circuitry to support the functionality of the ultrasound board 480. For example, the ultrasound board interface 475 may include circuitry to facilitate the calculation of parameters used in generating an image from ultrasound data provided by the ultrasound board 480. In some embodiments, the ultrasound board interface 475 is a SOC or other integrated system. In such a case, the ultrasound board interface 475 may be coupled directly to the main circuit board 405 as either a removable package or embedded package. The ultrasound board interface 475 includes connections which facilitate use of a modular the ultrasound board 480. The ultrasound board 480 may be a module (e.g., ultrasound module) capable of performing functions related to ultrasound imaging (e.g., multiplexing sensor signals from an ultrasound probe/transducer, controlling the frequency of ultrasonic waves produced by an ultrasound probe/transducer, etc.). The connections of the ultrasound board interface 475 may facilitate replacement of the ultrasound board 480 (e.g., to replace ultrasound board 480 with an upgraded board or a board for a different application). For example, the ultrasound board interface 475 may include connections which assist in accurately aligning the ultrasound board 480 and/or reducing the likelihood of damage to the ultrasound board 480 during removal and or attachment (e.g., by reducing the force required to connect and/or remove the board, by assisting, with a mechanical advantage, the connection and/or removal of the board, etc.).

In embodiments of the portable ultrasound system 200 including the ultrasound board 480, the ultrasound board 480 includes components and circuitry for supporting ultrasound imaging functions of the portable ultrasound system 200. In some embodiments, the ultrasound board 480 includes integrated circuits, processors, and memory. The ultrasound board 480 may also include one or more transducer/probe socket interfaces 465. The transducer/probe socket interface 465 enables ultrasound transducer/probe 470 (e.g., a probe with a socket type connector) to interface with the ultrasound board 480. For example, the transducer/probe socket interface 465 may include circuitry and/or hardware connecting the ultrasound transducer/probe 470 to the ultrasound board 480 for the transfer of electrical power and/or data. Transducer/probe socket interface 465 may include hardware which locks the ultrasound transducer/probe 470 into place (e.g., a slot which accepts a pin on the ultrasound transducer/probe 470 when the ultrasound transducer/probe 470 is rotated). In some embodiments, the ultrasound board 480 includes two transducer/probe socket interfaces 465 to allow the connection of two socket type ultrasound transducers/probes 470.

In some embodiments, the ultrasound board 480 also includes one or more transducer/probe pin interfaces 455. The transducer/probe pin interface 455 enables the ultrasound transducer/probe 460 (e.g., a probe with a pin type connector) to interface with the ultrasound board 480. The transducer/probe pin interface 455 may include circuitry and/or hardware connecting the ultrasound transducer/probe 460 to the ultrasound board 480 for the transfer of electrical power and/or data. The transducer/probe pin interface 455 may include hardware which locks the ultrasound transducer/probe 460 into place. In some embodiments, the ultrasound transducer/probe 460 is locked into place with a locking lever system. In some embodiments, the ultrasound board 480 includes more than one transducer/probe pin interfaces 455 to allow the connection of two or more pin type ultrasound transducers/probes 460. In such cases, the portable ultrasound system 200 may include one or more locking lever systems. In some embodiments, the ultrasound board 480 may include interfaces for additional types of transducer/probe connections.

With continued reference to FIG. 4, some embodiments of the main circuit board 405 include a display interface 430. The display interface 430 may include connections which enable communication between components of the main circuit board 405 and the display device hardware. For example, the display interface 430 may provide a connection between the main circuit board 405 and a liquid crystal display, a plasma display, a cathode ray tube display, a light emitting diode display, an organic light emitting diode display, and/or a display controller or graphics processing unit for the proceeding or other types of display hardware. In some embodiments, the connection of the display hardware to the main circuit board 405 by the display interface 430 allows a processor or dedicated graphics processing unit on the main circuit board 405 to control and/or send data to display hardware. The display interface 430 may be configured to send display data to display the device hardware in order to produce an image. In some embodiments, the main circuit board 405 includes multiple display interfaces 430 for multiple display devices (e.g., three display interfaces 430 connect three displays to main circuit board 405). In other embodiments, one display interface 430 may connect and/or support multiple displays. In some embodiments, three display interfaces 430 couple a touchscreen 310, a touchscreen 320, and a main screen 315 to the main circuit board 405.

In some embodiments, the display interface 430 may include additional circuitry to support the functionality of attached display hardware or to facilitate the transfer of data between the display hardware and the main circuit board 405. For example, the display interface 430 may include controller circuitry, a graphics processing unit, video display controller, etc. In some embodiments, the display interface 430 may be a SOC or other integrated system which allows for displaying images with display hardware or otherwise controlling display hardware. The display interface 430 may be coupled directly to the main circuit board 405 as either a removable package or embedded package. A processing circuit 410 in conjunction with one or more display interfaces 430 may display images on one or more of a touchscreen 310, a touchscreen, 320, and a main screen 315.

Generally, display circuitry may provide for the display of an image on a display screen. The image may result from user input (e.g., a pointer displayed as moving across a display in response to user input on a touch device or through a computer mouse). The image may also be one that is displayed upon the occurrence of certain triggering events, inputs, and/or objects. In some embodiments of the disclosure, an image is displayed using multiple displays of a multi-display device.

Referring still to FIG. 4, some embodiments of the disclosure include displaying images on a portable ultrasound system 200. In other embodiments, images may be displayed on or with other devices (e.g., portable computing devices, personal computing devices, etc.). In some embodiments, the main circuit board 405 and/or one or more display interfaces 430 control one or more displays. The displays are controlled to produce one or more images on one or more displays. The processing circuit 410 may determine what images and the characteristics of those images to display. The processing circuit 410 may further determine on which display to display the images in the case of a multi-display device. In some embodiments, these determinations are made based on user inputs. In other embodiments, the determinations are made in response to triggering events, inputs, and/or objects. The processing circuit 410 may make these determinations by executing, using a processor 420, instructions or computer code stored in a memory 415, stored in a hard disk storage 425, and/or acquired using a communications interface 440. In some embodiments, the processing circuit 410 retrieves, from the memory 415 and/or the hard disk storage 425, display instructions for an image to be displayed in response to executed code and/or instructions. The processing circuit 410 may then send control instructions to one or more display interfaces 430 which display an image according to those instructions on one or more displays. In some embodiments, the main circuit board 405 and/or the display interface 430 may include a graphics processing unit which performs or assists in preforming these functions.

For some events, instructions for displaying a certain corresponding image or series of images may be stored in the memory 415 and/or the hard disk storage 425. The occurrence of an event may trigger an instance in which the processor 420 retrieves the instructions and executes them. One such event may be receiving user input, such as receiving user input at the touchscreens 310, 320, or at peripheral sensors positioned around the display 215. By executing the instructions for displaying an image corresponding to an event, the processing circuit 410, one or more display interfaces 430, and/or display hardware cause an image or series of images to be displayed to a user.

In some embodiments, the main circuit board 405 includes a display control interface 485. The display control interface 485 can be similar to other components of the main circuit board 405, such as an ultrasound board interface 475. The display control interface is configured to communicate with a display control module 490. The display control interface 485 receive commands relating to the position and/or orientation of the display 215, and transmit the commands to the display control module 490. For example, the display control interface 485 can receive commands generated by the processing circuit 410 in response to user input received at the touchscreens 310, 320 and/or peripheral sensors positioned around the display via the user input interface 435, and transmit the commands to the display control module 490. The display control module 490 can receive the commands and control operation of the display 215 (e.g., using actuation components for controlling/articulating display 215). In some embodiments, the display control interface 485 transmits traverse, tilt, and/or swivel commands generated in response to user input received at the touchscreens 310, 320, and the display control module 490 electronically controls the position and/or orientation of the display 215 based on the traverse, tilt, and/or swivel commands. In some embodiments, the display control interface 485 transmits a command configured to deactivate electronic control of at least one of the position or orientation of the display 215 generated in response to user input received at peripheral sensors positioned around the display 215, and the display control module 490 deactivates electronic control (e.g., by decoupling actuation components from the display 215), allowing for a user to manually adjust the at least one of the position or orientation of the display 215.

In some embodiments, the main circuit board 405 includes an environment sensor interface 495. The environment sensor interface 495 can be similar to other components of the main circuit board 405, such as the ultrasound board interface 475 or the user input interface 435. The environment sensor interface 495 is configured to communicate with one or several sensors that make various measurements of the environment. For example, the environment sensor interface 495 can interface with an image capture device, such as a camera. The environment sensor interface 495 can also interface with an acoustical sensor. The environment sensor interface 495 can also interface with various other sensors, such as proximity sensors, ambient light sensors, or infrared sensors. The environment sensor interface 495 can receive commands relating to the execution or capture of environment data and transmit a signal to an interfaced sensor or sensors. Any of the sensors interfacing to the environment sensor interface 495 can be independently fixed to some part of the ultrasound system 200, such as display 215. In other embodiments, the sensors can mounted such that they be dynamically adjusted or moved.

In various embodiments, any combination of the display interface 430, user input interface 435, environment sensor interface 495, or display control interface 485 can be included in a single interface or module. For example, the same interface can be used to transmit visual information to be displayed on the touchscreens 310, 320 and/or the main screen 315, to receive user inputs from touchscreens 310, 320 and/or peripheral sensors positioned around the display 215, and to transmit position and/or orientation commands to control the position and/or orientation of display 215. In some embodiments, a first such combined interface can be used to communicate with the ultrasound electronics module 210 and components thereof, and a second such combined interface can be used to communicate with the display 210 and components thereof.

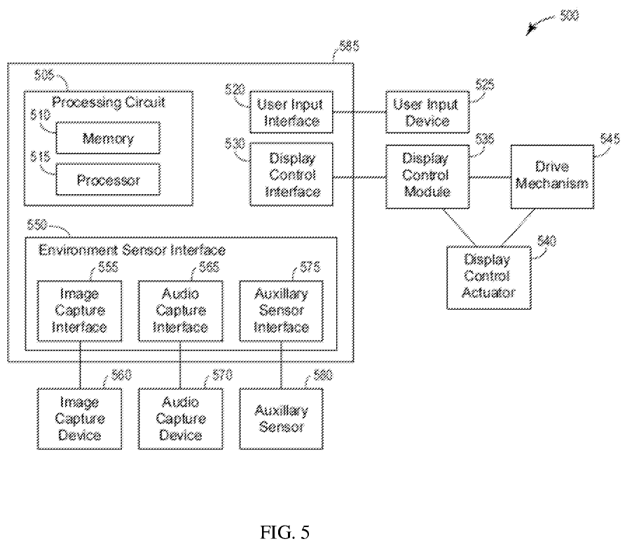

Referring now to FIG. 5, a block diagram of a control system 500 for controlling the position and/or orientation of a display 215 is shown, in accordance with some embodiments. The illustrated components can be similar or identical to the components described with reference to FIG. 4. The control system 500 includes processing electronics 585. The processing electronics 585 may be similar to main circuit board 480 as shown in FIG. 3. The processing electronics 585 includes a processing circuit 505 including a memory 510 and a processor 515, a user input interface 520, a display control interface 530, and an environment sensor interface 550 which can include an image capture interface 555, audio capture interface 565, and auxiliary sensor interface 575.

The user input interface 520 is configured to receive user inputs from a user input device 525. The user input device 525 may be similar or identical to the touchscreens 310, 320, keyboards, or other user input devices (e.g., other input devices shown in FIG. 3). The user input device 525 may be similar or identical to the sensors positioned around the display 215.

The user input device 525 receives user input that can indicate a command from a user. For example, the user input can indicate a command to adjust at least one of a position or orientation of the display 215, such as one or more of a traverse, tilt, or swivel command. The processing circuit 505 can receive the user input via the user input interface 520 and generate an output command to transmit to the control display 215 based on the command indicated by the user input. For example, the processing circuit 505 can process the user input to determine that the user input indicates a command to shift the position of the display 215 from a first side of the platform 205 to a second side of the platform 205 along a first axis, generate an output command based on the determination, and transmit the output command to display the control module 535 via the display control interface 530. The display control interface 530 receives output commands configured to control the position/orientation of the display 215 and transmits the output commands to the display control module 535. In some embodiments, a single command (e.g., a single gesture on a touch-sensitive interface) may be used to trigger movements in multiple directions. For example, a single swipe may be translated by the processing circuit 505 into both traverse and swivel movement (e.g., based on a stored mapping of input to movements of display 215).

In some embodiments, the processing circuit 505 provides advantageous modularity by being able to generate output commands based on user inputs received from touchscreens of any ultrasound electronics module 210. For example, the processing circuit 505 can process user input from a user input device of various ultrasound electronics modules 210, determine if the user input indicates one or more of a traverse, tilt, or swivel command, and generate an output command based on the determination. In some embodiments, the ultrasound electronics module 210 is configured to process the user input to determine if the user input indicates one or more of a traverse, tilt, or swivel command.

The display control module 535 is configured to control at least one of the position or orientation of the display 215. In some embodiments, the display control module 535 is located in electronics of control system 500. The display control module 535 may be associated with display electronics of the display 215 for outputting display information via the main screen 315. The display control module 535 is configured to transmit control commands to display the control actuator 540 and the drive mechanism 545. The display control module 535 may include processing electronics including a memory, such as a memory configured to store state information regarding whether the drive mechanism 545 is coupled to the display 215, and position/orientation information regarding a position and/or orientation of the display 215 and/or the drive mechanism 545 or components thereof. The display control module 535 can receive state information from the display control actuator 540 and the drive mechanism 545. In some embodiments, the state information can include a default or home position/orientation of the display 215, and the processing electronics 585 may be configured to cause the display 215 to be placed in the home position/orientation in response to a corresponding trigger condition such as reset command, a power up or power down of the ultrasound electronics module 210, a predetermined amount of time expiring, etc. Such a home position may be configured to align the display 215 with other components of the system such that, if the display 215 is tilted forward, it may be mated or locked into contact with a lower portion of the device for safe movement and/or storage.

In some embodiments, the drive mechanism 545 is configured to restrict motion about a tilt axis when the display 215 is outside of a center position along a traverse axis (e.g., to prevent the display 215 from being tilted down unless the display 215 is aligned in a proper position for stowing in the default position). In some embodiments, the drive mechanism 436 includes a cam or ramp configured to align the display 215 to a center position about a swivel axis when the display 215 is rotated to the default position. The cam or ramp may guide the display 215 about the swivel axis.

The display control actuator 540 is configured to activate or deactivate electronic control or articulation of the display 215. For example, the display control actuator 540 may mechanically couple/decouple the drive mechanism 545 from the display 215 (e.g., engage/disengage drive mechanism 545 from display 215) in response to a couple/decouple command received from the display control module 490. The display control actuator 540 may also interrupt an electronic connection (e.g., interrupt a circuit) between the display control module 535 and the drive mechanism 545, such as by receiving an interrupt command directly from the display control interface 530. In some embodiments, the display control actuator 540 is configured to default to maintaining the drive mechanism 545 in an engaged state with the display 215 unless a command is received with instructions to disengage the drive mechanism 545 (e.g., a command generated and received based on user input received at the sensors 280 to set the drive mechanism 545 in a neutral state, to set d the rive mechanism 545 in a manual mode allowing a user to manually adjust the position and/or orientation of the display 215, etc.). In some embodiments, peripheral sensors positioned about the display 215, or a portion thereof, may additionally or alternatively cause movement of the display 215. For example, detecting of pressing or movement on or near a left side of the display 215 may cause traverse movement in the left direction, and pressing or movement on or near a right side may cause movement in a right direction.

In some embodiments, disengaging the drive mechanism 545 from the display 215 may facilitate operating the display 215 in a free motion mode of operation. For example, the drive mechanism 545 can be configured to operate in a first mode in which the drive system is disengaged from the display 215, such that the display 215 is configured to move in response to receiving a force greater than a first force threshold. The drive mechanism 545 can be configured to operate in a second mode in which the drive mechanism 545 is engaged to the display 215, such that the display is configured to move in response to receiving a force greater than a second force threshold. The second force threshold is greater than the first force threshold. In some such embodiments, a user attempting to move the display 215 may perceive that the display 215 does not move while the drive mechanism 545 is engaged to the display 215 (e.g., the second force threshold is greater than a force at which the entire ultrasound system including the display 215 moves, rather than the display 215 moving relative to the remainder of the ultrasound system).

In some embodiments, processing the electronics 585 may be configured to receive a user input from peripheral sensors positioned around the display 215 and control operation of the drive mechanism 545 to control or assist motion of the display 215 based on the command. For example, the user input may indicate one or more of a traverse, swivel, or tilt motion, and processing the electronics 585 may be configured to engage (or maintain engagement) the drive mechanism 545 with the display 215, and cause the drive mechanism 545 to provide traverse, tilt, and/or swivel output to the display 215 based on the user input.

The drive mechanism 545 is configured to cause the display 215 to change in at least one of position or orientation. For example, the drive mechanism 545 may be located inside of a housing of platform 205 and be configured to be coupled (e.g., engaged) to display 215 or components thereof. The drive mechanism 545 can include one or more drives (e.g., motors, linear actuators, etc.) configured to apply forces to the display 215 to adjust the position and/or orientation of the display 215 in response to commands received via the display control module 535. For example, the drive mechanism 545 can be configured to translate the display 215 along an axis (e.g., shift the position of the display 215 side to side along a traverse axis), as well as to rotate the display 215 about one or more axes (e.g., rotate the display 215 about a tilt axis and/or a swivel axis). In some embodiments, the drive mechanism 545 includes a plurality of drives each dedicated to cause one of a traverse motion, a swivel motion, or a tilt motion.

For example, the display control module 535 may receive a command from the display control interface 530, the command including instructions to traverse the display 215 to the left (based on a frame of reference of a user facing the main screen 315 of the display 215) by a certain distance and tilt the display 215 by fifteen degrees towards the platform 205. The display control module 535 controls operation of the display control actuator 540 to engage drive mechanism 545 to display 215. The display control module 535 controls the drive mechanism 545 to cause the desired traverse and tilt of the display 215.

In another example, the display control module 535 may receive a command from the display control interface 530, the command including instructions to decouple the drive mechanism 545 from the display 215. In some embodiments, the display control module 535 transmits a command to the display control actuator 540 configured to mechanically disengage the drive mechanism 545 from the display 215. In some embodiments, the display control actuator 540 directly receives an interrupt command from the display control interface 530 to interrupt an electronic connection between the display control module 535 and the drive mechanism 545.

In some embodiments, the peripheral sensors about the display 215 are configured to detect at least one of a force or a direction associated with the user input. The display control module 535 can cause a force-assisted movement of the display 215 based on the user input detected by the peripheral sensors. For example, the display control module 535 can cause movement of the display 215 based on the detected force being greater than a force threshold. The display control actuator 540 can cause the drive mechanism 545 to move the display 215 (e.g., traverse, tilt, or swivel the display 215) in a direction corresponding to the detected direction (e.g., move in the same direction; move in a direction determined based on decomposing the detected direction into movement along or about at least one of a traverse axis, a swivel axis, or a tilt axis). In some such embodiments, the display control module 535 can enable a force-assisted movement, such that a user applying a force to the peripheral sensors perceives the display 215 to move together with the force applied by the user. For example, the display control actuator 540 can be configured to cause the display 215 to move within a predetermined time after the peripheral sensors receive the user input.

The environment sensor interface 550 can be configured to receive data from the environment 100 in which the portable ultrasound system 200 operates. In various embodiments, the environment sensor interface 550 can include, but is not limited to, an image capture interface 555, an audio capture interface 565, an auxiliary sensor interface 575, or any combination therein. In various embodiments, the image capture interface 555, the audio capture interface 565, or the auxiliary sensor interface 575 can be implemented as separately distinct interfaces or components.

The image capture interface 555 can send and receive signals from an image capture device 560 and transmit data to the processing circuit 510. The image capture device 560 could be, but is not limited to, a still-image camera, video camera, or infrared camera. The image capture interface 555 may send instructions to the image capture device 560. The image capture interface 555 may receive image data form the image capture device 560. The received image data can include one or more captured images. In some embodiments, the image capture device 560 may be configured within the portable ultrasound system 200. In some embodiments, the image capture device 560 may be placed or mounted on the outside of the portable ultrasound system 200. In some embodiments, the image capture device 560 can be mounted on the display 215. In some embodiments, the image capture device 560 may be mounted or placed within the environment and connected to the portable ultrasound system 200. In some embodiments, the image capture device 560 may interface via a network interface of the portable ultrasound system 200.

In some embodiments, multiple image capture devices 560 may be connected to the image capture interface 555. In some such embodiments, the multiple image capture devices 560 may be configured to provide depth perception of captured images stereoscopically. In some embodiments, the multiple image capture devices 560 may provide a larger field of view for object tracking. In some embodiments, the multiple image capture devices 560 can be used to reduce error in image signals.

The audio capture interface 565 can send and receive signals from an audio capture device 570 and transmit data to the processing circuit 510. The audio capture device 570 can be any device that can sense, collect, or filter acoustic energy into electrical signals. In some embodiments, the audio capture device 570 is a microphone. The audio capture interface 565 may be able to send instructions to the audio capture device 570. The audio capture interface 565 may receive audio data captured by the audio capture device 570. The audio data may include voice commands given by a user. The audio data may also be used to locate the source of an acoustical signal within the environment. The audio capture device 570 may be located within, mounted on, or place on the portable ultrasound system 200. In some embodiments, the audio capture device 570 may be placed or mounted in the environment and connected to the portable ultrasound system 200 by a wire, or wireless transmitter and receiver.

In some embodiments, multiple audio capture devices 570 can be connected to the audio capture interface 565 and used in combination. In some such embodiments, the multiple audio capture devices 570 can be configured to capture acoustical signals from different parts of the environment. In some embodiments, the multiple audio capture devices 570 can be used to triangulate the position of the acoustical signal source, such as a person, or the user designated as the target. In some embodiments, the multiple audio capture devices 570 can be used to reduce signal error in the captured audio data.

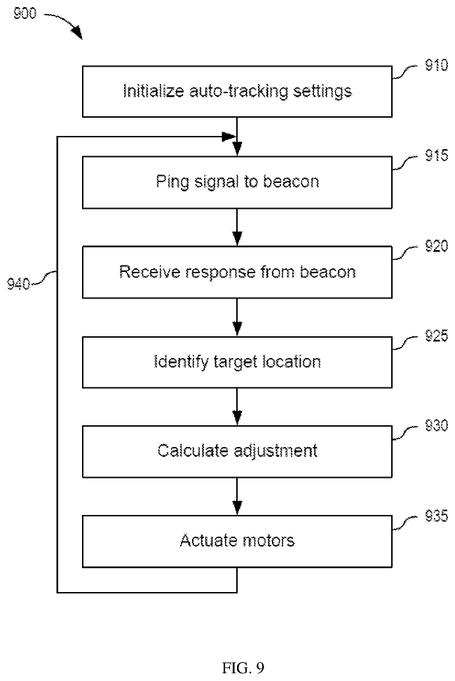

The auxiliary sensor interface 575 may be used to send signals to and receive signals from one or more auxiliary sensors 580. In some embodiments, the auxiliary sensor 580 is a light sensor that measures the ambient light intensity of the environment. In some such embodiments, one or more light sensors are mounted near or one the display 215 to measure the light intensity directed at the display 215 to predict glare intensity. hi some embodiments, the auxiliary sensor 580 is a proximity sensor, such as, but not limited to, radar, photoelectric, ultrasonic, sonar, infra-red, or laser sensor. The proximity sensor may be used to measure the distance the target or an object is from the display 215 or the portable ultrasound system 200. In some embodiments, the auxiliary sensor 580 is used to locate a beacon carried by the user by transmitting signals to the beacon and receiving signals in return from the beacon. In some such embodiments, the auxiliary sensor 580 can send wireless power signals to the beacon. Beacon tracking implementations will be discussed in more detail in references to FIG. 9.

Multiple auxiliary sensors 580 can be connected to the auxiliary sensor interface 575. The multiple auxiliary sensors 580 can be different types of sensors and provide different functionalities. In some embodiments, the multiple auxiliary sensors 580 are the same type of sensors and can be provide similar benefits as those discussed with the multiple image capture devices 560 or the multiple audio capture devices 570, such as signal error reduction, location triangulation, or location-dedicated signal capture.

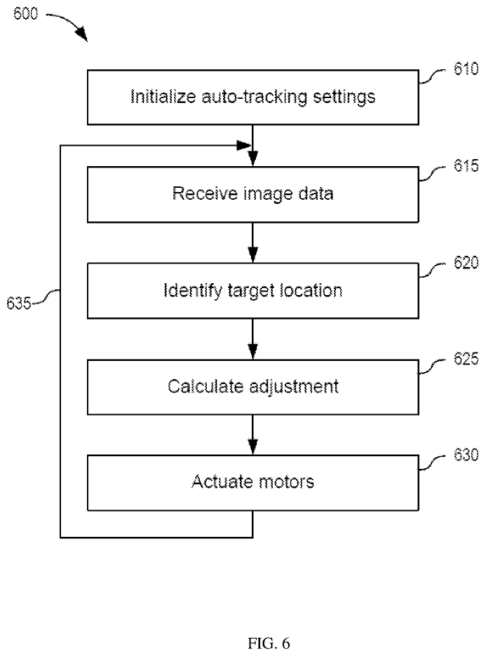

Referring now to FIG. 6, a flow diagram 600 for automatically adjusting a display using image data is shown, according to some embodiments. The functions of flow diagram 600 can be performed by a variety of systems as described herein, including the portable ultrasound system 200 or the control system 500. For example, the control system 500 can adjust at least one of the position or orientation of the display 215 via the display control module 535 according to various input. The control system 500 may track a designated target within an environment based on identification of the target in a captured image via the image capture interface 555. The functions described in the flow diagram 600 or portions thereof can be performed based on settings that can be dynamically changed during use. Multiple iterations of the functions of the flow diagram 600 may be performed so as to automatically adjust the display continuously or periodically.

At 610, the control system initializes the automated display control. Initialization of the automated display control can include defining various settings and determine the target or targets for the system to track. After initialization processes are complete, the control system may begin automatic tracking and display adjustment. In some embodiments, the system waits to enter automatic tracking until receiving a user input at a user input interface indicating the system should begin automatic tracking.

In some embodiments, the control system enters the initialization phase in response to the portable ultrasound system being powering on from a sleep state or powered-off state. In some embodiments, the initialization of the automated display control is performed in response to receiving, by the system at user input interface, a user input on a user input device indicating that the automated display control should be initialized or that automatic object tracking should be engaged. In some embodiments, the automated display control can be initialized based on predetermined settings stored in the memory. In some embodiments, the control system may generate a graphical user interface on the display and accept input from one of the user input device to define the system settings.

In some embodiments, an input including one or more of input credentials, log-in, or other identification information may be received via a user input interface, enabling a user to identify themselves to the system. In response to receive the input, the can automatically define the system settings according to the identity of the user and the user's preferences. In some such embodiments, the system uses facial recognition software or voice recognition software to identify the user. The system may store and retrieve these settings from memory. In other embodiments, the system may store and retrieve these settings in an external server or database. Likewise, a system may retrieve template images associated with the identified user to automatically identify the user as the target in subsequent image data.

In some embodiments, the control system may detect that automatic tracking mode is engaged, identify that a target should be determined, and in response, perform a series of steps to identify the target to track in the automatic tracking mode. In some such embodiments, the information used to identify the target or user is saved in the memory, and is compared to one or more captured images to identify the target using image processing techniques. Image processing techniques, including facial recognition algorithms, will be discussed in more detail in relation to step 620. In some embodiments, the target can be identified manually by capturing data and prompting user input to indicate the target within the image data. For example, the system, as a part of the initialization process, may output a prompt via a user input interface indicating instructions for a user to stand within the image frame, capture an image with an image capture device, receive the image via an image capture interface, and identify which group of pixels in the captured image are associated with the target to be tracked by the system. In some embodiments, the user may be prompted via a display to construct a box around the target using one of user input devices. In other embodiments, the control system may use facial recognition algorithms to identify a target in the captured image or images, and the user may be prompted to confirm that the computing system correctly identified the target to track in the image. In some embodiments, the control system may be configured to use generic facial recognition algorithms to identify the features of a human face or body, such that individuals are identified and tracked but are not associated with a specific user's identity.

During initialization, the control system can also determine target viewing settings. In some embodiments, the target viewing settings includes a target viewing angle. The target viewing angle can be set such that the screen is directly normal to a target's line of sight (commonly defined as a viewing angle of zero degrees). In some embodiments, a user can adjust the target viewing angle to their own preference. This adjustment can be embodied by a setting stored in memory that stores positions or orientations along one or more degrees of motion. The stored target viewing angles be a relative angle (e.g., 3 degrees above the display normal), or an absolute angle (e.g., a 45 degree viewing angle). The target viewing settings can also disable various degrees of motion according to environmental factors or to the user's preference.

Additional and alternative settings will be described in more detail below. All such settings can be defined during the initialization processes as described herein.

Automatic tracking begins an iteration at 615. At 615, image data is received from the image capture device at an image capture interface. The image data contains information about the position of the target or targets in the environment. In some embodiments, the image data can be received or updated in real time from the image sensor. In some embodiments, a processing circuit sends a command or request to the image capture device via image capture interface to capture an image. In some embodiments, the image data is retrieved from memory. hi some embodiments, the image data received at 615 can contain multiple images.

At 620, the position of the target or targets is determined from the captured image data. In some embodiments, the position is determined relative to the portable ultrasound system. In some embodiments, the position of the target or targets is located relative to the at least one of position or orientation of the display. In some embodiments, the position of the target or targets is determined relative to the image capture device. In some embodiments, the position of the target or targets can be determined as coordinates on a coordinate grid. In some embodiments, the coordinate grid is the coordinate system of the image data received from the image capture device.

In some embodiments, the position of the target or targets is determined by performing motion tracking analysis on multiple frames to identify movement between the multiple frames. In some such embodiments, pixels may be extracted from one or more images, compare pixels of one frame to pixels of another to identify object movement between the frames, compare identified movement to a previous known position of the target, attribute the movement to the target based on the previously known position of the target, and determine the new position of the target based on the identified movement.

In some embodiments, the control system is configured to compare an image received at 615 with a reference image (also referred to as template or template image) to identify the location of a target within the image frame. In some such embodiments, the reference image may be capture during the initialization process at 610. In template matching algorithms, the reference image can be retrieved from a stored database of reference images. The control system can then extract pixels from the image data, compares the pixels to the reference image, and, in some embodiments, assign the extracted pixels a match score. The extract pixels that most closely matches the reference image can be designated as the target. In embodiments with a match score, the pixels with the highest match score may be designated as the target. I some embodiments, a threshold score may be compared to the extracted pixel's match score, and if the match score is less than the threshold score, the pixels may be considered ineligible to be considered the target. In some embodiments, template matching algorithms may use a previous location of the target to more efficiently identify the target.

In some embodiments, the control system is configured to input the captured image into a machine learning model. In some such embodiments, machine learning models are trained either through supervised learning (such as, but not limited to, neural networks or support-vector machines) or unsupervised learning (such as, but not limited to, classifier algorithms). The machine learning model then is configured to output the location of the target within the image data.

In some embodiments, where the target is identified within image data, a specific pixel or group of pixels may need to be defined as the target's location, rather than the entire group of pixels. For example, the center of the identified region or group of pixels may be used as the location of the target. In another example, a specific feature of the pixels may be used, such as the pixels associated with the user's eyes.

In some embodiments, a target is located within the surrounding environment by processing the location of the target within the image data. In some embodiments, the system maintains a mapping of locations and distances relative to the portable ultrasound system or display. In some embodiments, the mapping uses a non-relative grid system. To locate the position of the target, a system may maintain information about the current pose and position of an image capture device. In some embodiments, the location of the camera relative to the display or portable ultrasound system is considered in determining the location of the target. A control system may use geometric algorithms to estimate a target's location in a grid system. Image processing algorithms can be used to identify the distance an object in the captured image is from the image capture device. For example, the height of a target may be measured in pixels, and compare that to a known dimension of the target (such as a user's height, or the average height of a user) to make a distance estimation. Additionally or alternatively, a proximity sensor may be used to measure the distance a target is from portable ultrasound system. The combination of these metrics, among others, can be used to map an identified target in image data to a location in the map.

In iterations target identification where the target cannot be identified in an image, other methods may be implemented to reconcile the deficiency. In some embodiments, an image processing technique may be used to interpolate the target's location from other data. For example, the system may be configured to identify the user's face, but the user may have turned away from the camera. In such an example, the system may be able to identify the back of the user's head as a proxy target, and will adjust the display according to the identified proxy target. In some embodiments, the system may use other tracking means, such as voice tracking. In such an example, the system may be caused to identify the user's voice within captured audio data and identify the user's location based on the identified voice features. In some embodiments, the system may be caused to halt automatic display adjustment until the target can be properly identified again in the captured image data. For example, another person or object may have moved in between the image capture device and the target obstructing view of the target. The system may continue to capture images until the target can be located again, and subsequently resume automatic adjustment.

At 625, after identifying the location of the target to be tracked, necessary adjustments of the display are calculated to accommodate a change in location or position by one of the targets. In some embodiments, the calculated adjustments are based on the new location of the target (i.e., an absolute adjustments). In other embodiments, the system stores the previous position and orientation of the display to calculate a new position and orientation relative to the previous position and orientation (i.e., a relative adjustment). In embodiments using motion tracking, the adjustments may be based on the calculated movement. Adjustments can be based on configured degrees of motion of the one or more available actuators. In systems with multiple actuators, more complex adjustments can be calculated based on control settings. The system may utilize a control algorithm, such as determining a different between a target pose and an actual pose of the display, and generating a control signal based on the difference. The control algorithm may be, for example, a closed loop control, PID, or any other control algorithm.

In some embodiments, a determination of whether the target has moved locations since the last measurement is made. To do so, the difference between the current identified position of the target to a previous position of the target may be compared to a given threshold, and if the difference is less than the threshold, the determination is that the target has not moved, and may cause the display to make no adjustment. In some embodiments, the calculated adjustment may be compare to a given threshold, and if the calculated adjustment is less than the given threshold, the determination may cause the display to make no adjustment. In iterations where a control system elects to make no adjustment to the position or orientation of the display, the control system may skip subsequent functions and return to step 615, for example.

At 630, a drive mechanism controlled according to the calculated adjustment. In some embodiments, the adjustment is an incremental change in a control state of the drive mechanism. In some embodiments, the adjustment is an input or state for a control algorithm maintained by display control module. A display's position and orientation can be manipulated via various configurations of degrees of freedom defined by the configuration of the drive mechanism. The drive mechanism may comprise multiple drives used in combination to achieve a desired adjustment. The drive mechanism may individually be controlled by a control algorithm, such as, for example, a closed loop control, PID, or any other control algorithm.

After concluding display adjustment at 630, a control system may be configured to begin another iteration of automatic tracking and adjustment via path 635. The control system may be configured to begin a new iteration of automatic tracking starting at 615. In some embodiments, the control system determines at 635 if the automatic tracking is activated and if the display should be adjusted based on an adjustment frequency setting (i.e., the frequency with which the display control automatically adjusts the display). The adjustment frequency may be defined during the initialization at 610 by the user or retrieved from memory. In some embodiments, the control system uses a timer trigger configured to activate according to the determined adjustment frequency.

In some embodiments, the display control can adjust the display continuously. Continuous adjustment to the display may be limited by hardware and software operating speeds, and thus should be understood to mean the control system repeats the functions of the flow diagram 600 again at 615 without intentional delay. In some embodiments, the adjustment frequency is set such that the control system adjusts the display periodically according to a time delay or repetition. The frequency with which the display control adjusts the display can be changed dynamically per user input during use. The adjustment frequency setting may be useful to reduce distracting movement or annoyance.

In some embodiments, the display control system only adjusts the display once and waits for additional user input before moving the screen again (may be referred to as a single adjustment). When the control system does not enter another iteration of display adjustment, the control system may enter a sleep state to wait for an indication to adjust the display. In some embodiments, the indication is a new user input via user input interface or from a sensor interface.

In some embodiments of the automated display control 600, multiple targets may be indicated to be tracked by the control system. For example, in some embodiments, a user indicates multiple targets present within an image frame to track as discussed at 610. In some embodiment, the system uses facial recognition software to recognize multiple user's in a frame. In various embodiments, users can be dynamically added or removed as targets. For example, in some embodiments, if a user leaves the image frame, the user will be removed as a target and no longer tracked. In some embodiments, a new user who enters the image frame will be recognized by facial recognition software and added as a new target to track. Additional setting defined at 610 may include how to adjust the display for the multiple targets. In some embodiments, the system adjusts the display to an average position between the multiple identified targets. In another embodiment, the system identifies a priority target and adjusts the screen only to the identified priority target according to their target settings and allow the display tracking to be switched between users per user input.

In some embodiments of the automated display control 600, one or more home positions for the display can be defined. A home position may be defined as the position and orientation of the display in which to reside by default. A home position could be used for a powered-off mode. A home position could be the default viewing position for a user utilizing certain input devices, such as shown in FIG. 2. Multiple home positions may be defined for any number of use cases. To determine a home position, the position and orientation may be stored in memory as a static state. In some embodiments, the user may manually adjust the display and indicate that the final position and orientation should be defined as a home position.

In some embodiments of the automated display control 600, the display can be adjusted between discrete display positions in a finite set rather than on continuous spectrums. For example, either a user, or system configurations, can define a set of positions to which the display can be adjusted. In such an embodiment, the automatic display system response to user and sensor input to adjust the display between these defined positions based on which position would be best suited for the target's current position, but does not adjust the display to a position not defined in the set. Such an embodiment could reduce unnecessary movements when the number and nature of positions a user could be in are routine or finite.

In some embodiments of the automated display control 600, the control system may retrieve voice recognition algorithms stored from memory to process audio data received at an audio capture interface to further locate a user in the environment in addition or alternative to image tracking. In some embodiments, a specific user's voice features may be retrieved from memory and compared to captured audio data to identify the user's voice in the received audio data and determine the source position of the identified voice. Such voice feature data may be retrieved in response to identifying the target or user, such as those discussed at 610.

In some embodiments of the automated display control 600, the control system can be interrupted by an input configured as an override. In some embodiments, the override can interrupt the control system at any point in its implementation of the automated display control 600. In other embodiments, the override can only interrupt the method during path 635 as not to halt or interrupt an iteration of display adjustment. The override can be, but is not limited to, a display adjustment command or a setting change. Overrides can be generated from various input methods, such as voice recognition software that analyzes audio data captured by an audio capture device, a user input via a user input interface, or some other sensor in which the display control system can identify a user override. In some embodiments, overrides may inherently deactivate the automatic tracking mode or set a predefined waiting period before reengaging the automated display control 600 again at 615. Overrides may also enter the system into step 610 for reconfiguration of control settings.

A display adjustment command configured as an override can adjust the screen to a specified position or orientation. In some embodiments, an adjustment command can return the display to a pre-defined home position. In some embodiment, an override command incrementally adjusts the screen position or orientation (e.g., tilt the screen 5 degrees upward, raise the screen two inches, etc.). In some embodiments, while the display is in a sleep state, an override command can indicate to the system to make a single display adjustment (i.e., perform the functions of 615-630 without automatically repeating the sequence afterwards). Example adjustment commands may include, but are not limited to, hold the display in place (i.e., sleep, wait, stop, or pause commands), incremental movements, return to a home position, or make a single adjustment (“here”, “update”, “follow me”, “look at me”). The adjustment commands can be chosen based on a user's or use case preference.

An override may also change system operating settings. For example, a user may indicate to enable or disable the automatic tracking mode. In other embodiments, the user may change the frequency by which the display automatically adjusts. Any setting or parameter described in step 610 can be changed with an override.

An override may also be a manual override. In some embodiments, a display has sensors around the perimeter of the display, and when the sensors detect a user's touch, electrically disengages the drive mechanism from the display using a display control actuator to allow the user to manually adjust the display. In some embodiments, the display system has a physical latch that when pulled allows the display to be adjusted by disengaging the drive mechanism from the display using the display control actuator. Such manual overrides may halt a processing circuit from performing the outlined functions of automated display control 600.

The display may also implement, in addition to the functions and configurations described, automatic glare reduction methods. In various embodiment, light intensity sensors are configured to measure the amount of light directed at the display. In some embodiments, the system adjusts the display until the measured light intensity by an ambient light sensor become acceptable for viewing. In other embodiments, the system adjusts the screen brightness such that, when there is more intense light detected, the display is brighter, and when there is less intense light measured, the display dims. In yet another embodiment, the screen may include an electro-chromic material added to the display that dim or brighten depending on the voltage applied. In such an embodiment, the system changes the voltage to the electro-chromic material according to the amount of light detected to reduce viewing glare. Such a feature can be activated or deactivated in a configuration or initialization phase. Additionally or alternatively, anti-glare features can be adjusted with overrides, such as voice commands or user input from a user input device.

A portable ultrasound system may also be configured to receive commands to adjust information displayed on its screen. For example, a user may make vocal speech commands to zoom in or out of data displayed on the screen, navigate a menu or display structure, or enter a different viewing mode. In some embodiments, a user may be able to adjust the settings of the ultrasound processing system, such as, but not limited to, frame rate, depth, ultrasound frequency, imaging mode, etc. Likewise, such screen commands can be implemented with the display adjustments of the automated display control 600. For example, the portable ultrasound system 200 may be configured to automatically zoom in on data or images displayed on the screen 315 when the system recognizes that the user is a distance away from the display. In another example, an ultrasound system may automatically enter a menu mode when a user is positioned directly in front of a user input device (such as the platform 210) and otherwise display an ultrasound imaging mode when the user is moving about the local environment.

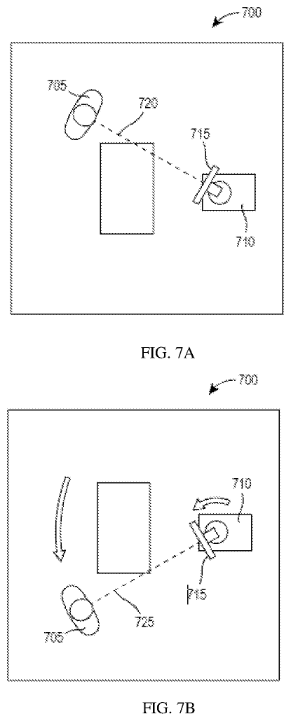

Referring now to FIG. 7, a use case of the control system 500 is shown, according to some embodiments. In the environment 700, a user 705 is interested in viewing the screen of a display 715 of ultrasound system 710. The display 715 is mounted to an ultrasound system 710 via one or more motors such that the display can be rotated and shifted variously. In FIG. 7A, the user 705 has a line-of-sight 720 to the display 715, to which the display 715 can adjust to reflect user preferences discussed herein for a target viewing angle or adjustment. In FIG. 7B, the user 705 has moved to a different location in the room relative to the ultrasound system 710. As such, processing electronics within ultrasound system automatically track the movement of the user 705 and adjust the display 715 to establish a new line-of-sight 725. Thus, the user 705 can move about the environment 700 while still maintaining a view of the display 715.

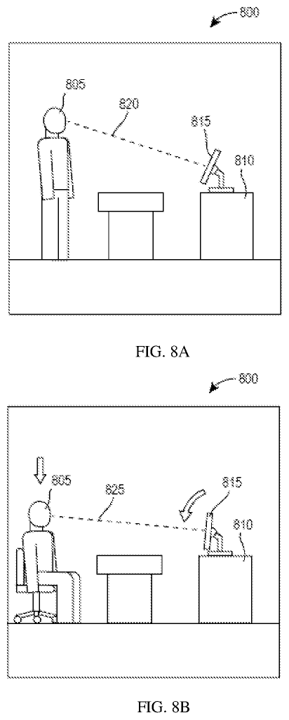

Referring now to FIG. 8, another use case of the control system 500 is shown, according to some embodiments. In environment 800, a user 805 is interested to view a display 815 of an ultrasound system 810. In FIG. 8A, the user 805 is standing and viewing the display 815 with a line-of-sight 820. The user 805 may change their posture or position, such as standing, sitting, leaning over, resting on a knee, kneeling, squatting, or some other posture, such that the display becomes out of target view, or out of view entirely. In FIG. 8B, the user 805 takes a seated position, and processing electronics coupled to the ultrasound system 810 automatically adjust the display 815 to rotate the screen down such that the line-of-sight 825 can be maintained by the user 805. The adjustments demonstrated in FIG. 7 and FIG. 8 can be utilized alone or in combination to allow a user to maintain a desired view of a display as they move about the local environment.

Referring now to FIG. 9, a flow diagram 900 for automated display control by a beacon system is shown, according to some embodiments. The functions of the flow diagram 900 can be performed by, for example, the portable ultrasound system 200 or control system 500 utilizing a beacon tag carried by the user to locate the target object. The system may employ any type of beacon, such as, but not limited to, radio-frequency (RF), infra-red, or some other communication emitter and receiver. Potential beacon devices could include, but are not limited to, a clip-on badge, specialized glasses, a lanyard, chip, mobile phone, or some other technology. The portable ultrasound system 200 can includes one or more receivers able to detect the location of the beacon with in the environment, such as the auxiliary sensor 580 at the auxiliary sensor interface 575. In some embodiments, the beacon is an active component and periodically sends a signal to the receiver. In some embodiments, the beacon is a passive device and only sends a signal when triggered by a request signal by the portable ultrasound system. In yet another embodiment, the beacon can be a mobile user device, such as a mobile phone, that is carried by the user.

Similar to functionality at 610 in the flow diagram 600, a control system may begin initialization at 910. Initialization can include any settings or configurations discussed in relation to initialization at 610 of flow diagram 600. Initialization at 910 may also include additional configurations related to the beacon system. For example, step 910 could determine, in any combination or subset, how many beacons should be tracked by the control system, which beacon of a plurality of beacons may be designated a priority beacon, signal characteristics such as signal frequencies or signal power, assigned beacon addresses or identifiers, Bluetooth initialization, a period between beacon pings, height of the user, or any other initialization necessary for transmitter-receiver pairs.

Automatic tracking begins by sending a ping signal to the beacon at 915. In some embodiments, a processing circuit sends a command to a transducer to send the ping signal. A ping signal generally indicates to the beacon to send a response signal that can be used to locate the beacon. The ping signal can include multiple or repeated signals. In some embodiments, where the beacon is a passive component, the ping signal may also include a wireless power component to power the beacon temporary. In some embodiments where the beacon is an active component, step 915 may be omitted, and the beacon may be configured to periodically send a response signal to the ultrasound system.

The control system then receives a signal from the beacon at 920. In some embodiments, the control system receives the signal from the connected transducer or other receiving element. The received response signal includes information to locate the beacon within the local environment. In some embodiments, the beacon response signal can include multiple or repeated signals. In some embodiments, the response signal may be received at multiple receiver sensors coupled to the ultrasound system. The functions performed at 920 can include any filtering, amplification, noise reduction, envelope detection, or any other signal processing to retrieve information from the received response signal, and can be done either via analog or digital hardware.

At 925, the beacon is located within in the local environment based on the received response signal. In some embodiments, the response signal is received at multiple receivers and the location of the beacon is calculated based on differences in the received data, such as triangulation techniques. In some embodiments, the ultrasound system uses known timing parameters to determine a beacon's location based on the response signal delay from the ping signal. Other embodiments rely on the delay between the reception of the signal and a corresponding time stamp. Any such location detection method can be used by a control system at 925.

At 930, the necessary adjustments of the display pose are calculated based on system settings and configurations. The functions performed at 930 can include any configurations discussed at 625 of flow diagram 600. The height of the user may be taken into account to know at what angle the display should be positioned. A control system may make assertions of a user's posture (i.e., standing, sitting, kneeling, leaning over, etc.) based on relative changes in a beacon's height from the floor.

At 935, the control system actuates the motors according to the calculated adjustments determined in 930. The functions of 935 can be performed similarly to those of 630 of the flow diagram 600. The control system adjusts the display such that the user can better view the display while moving about the environment.

The functions of the flow diagram 900 can be repeated via path 940. The process 900 can be repeated similar to that of process 600. A control system may repeat the functions of flow diagram 900 again at 915. Display adjustments may be halted based on a predetermined amount of time before the next display adjustment, such as the adjustment frequency setting. A control system can include interrupts similar to those discussed at the flow diagram 600. Interrupts and overrides can come from any input device or sensor, such as an image capture device, audio capture device, remote controller, input interfaces on the beacon, or any other discussed means.

Beacon-receiver embodiments such as that discussed in FIG. 9 allow the automatic display adjustment system to operate in conditions where it is difficult to identify a target within an image frame, such as in low-light conditions or when objects block the target from view of the image capture device. Beacon-receiver embodiments can be used in addition to, or in the alternative from, the image tracking system herein described.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for automatically adjusting a display, the method comprising:
initializing an automated display control;
receiving image data;
determining a position or an orientation of a target relative to the display based on the image data;
calculating an adjustment of the display based on the position or the orientation of the target relative to the display; and
controlling at least one actuator based on the adjustment of the display to move the display.

2. The method according to claim 1, wherein after the controlling the at least one actuator based on the adjustment of the display to move the display, the method further comprises:
beginning an iteration of the method at a start of the receiving image data.

3. The method according to claim 2, wherein before the beginning the iteration of the method at a start of the receiving image data, the method further comprises:
determining whether an automatic tracking is activated and whether the display is adjusted based on an adjustment frequency; and
in response to the automatic tracking being activated, performing the beginning the iteration of the method at a start of the receiving image data with the adjustment frequency.

4. The method according to claim 3, wherein the adjustment frequency is changed dynamically.

5. The method according to claim 1, wherein the determining the position or the orientation of the target relative to the display based on the image data comprises:
performing motion tracking analysis on a plurality of frames of the target to identify a movement between the plurality of frames.

6. The method according to claim 5, wherein the calculating the adjustment of the display based on the position or the orientation of the target relative to the display comprises:
calculating a movement of the display based on a result of the motion tracking analysis; and
adjusting degrees of motion of the at least one actuator to realize the movement of the display.

7. The method according to claim 1, wherein in response to the position or the orientation of the target being not determined, the method further comprises:
interpolating the position or the orientation of the target from other data by an image processing technique; or
performing voice tracking; or
beginning an iteration of the method at a start of the receiving image data until the position or the orientation of the target is determined.

8. The method according to claim 1, wherein the calculating the adjustment of the display based on the position or the orientation of the target relative to the display comprises:
determining a difference between the position or the orientation of the target and an initial position or an initial orientation of the target;
comparing the difference with a threshold; and
determining the adjustment of the display as zero in response to the difference being less than the threshold.

9. The method according to claim 1, wherein the calculating the adjustment of the display based on the position or the orientation of the target relative to the display comprises:
in response to the number of identified targets being more than one, calculating the adjustment of the display based on an averaged position or an averaged orientation of the identified targets.

10. The method according to claim 1, wherein the calculating the adjustment of the display based on the position or the orientation of the target relative to the display comprises:
in response to the number of identified targets being more than one, configuring one of the identified targets as a priority target; and
calculating the adjustment of the display based on the position or the orientation of the priority target;
wherein the priority target is switched among the identified targets based on a user input.

11. The method according to claim 1, wherein the controlling the at least one actuator based on the adjustment of the display to move the display comprises:
controlling the at least one actuator to move the display at a certain position or a certain position orientation selected in a finite set.

12. The method according to claim 1, further comprising:
receiving audio data; and
determining the position or the orientation of the target relative to the display based on the audio data.

13. The method according to claim 1, wherein the method is interrupted, terminated, set or reset, in response to an input configured as an override being received.

14. The method according to claim 1, further comprising:
receiving a user gesture; and
controlling the position or the orientation of the display based on the user gesture.

15. The method according to claim 14, wherein before the controlling the position or the orientation of the display based on the user gesture, the method further comprises:
electrically disengaging a drive mechanism from the display to allow manually adjustment of the display, in response to a user touch being detected.

16. The method according to claim 1, further comprising:
receiving a response signal from the target; and
determining the position or the orientation of the target relative to the display based on the response signal.

17. The method according to claim 16, wherein in response to the target being a passive component, before the receiving the response signal from the target, the method further comprises:
sending a ping signal to the target.

18. The method according to claim 16, wherein in response to the target being an active component, the target is configured to periodically send the response signal.

19. The method according to claim 16, wherein the response signal is a radio-frequency or infra-red signal.

20. A display adjustment system, comprising:
a display;
at least one actuator, being capable of moving the display;
an image capture device, mounted to the display and configured to receive image data; and
processing electronics, configured to perform a method for automatically adjusting a display, the method comprising:
initializing an automated display control;
receiving image data;
determining a position or an orientation of a target relative to the display based on the image data;
calculating an adjustment of the display based on the position or the orientation of the target relative to the display; and
controlling the at least one actuator based on the adjustment of the display to move the display.
